(19) United States
(12) Patent Application Publication
(10) Pub. No.: US 2012/0112562 A1
(43) Pub. Date: May 10, 2012

(54) TIMING POWER SWITCH

(76) Inventor: Jui-Hsiung Wu, Taipei (TW)

(21) Appl. No.: 12/940,036

(22) Filed: Nov. 4, 2010

(51) Int. Cl. H01H 33/59

(52) U.S. Cl. 307/141.4

(57) ABSTRACT

A timing power switch includes a power module for getting and dealing with an AC input voltage, a switch module having an electromagnetic relay and a driving circuit, and a control module which includes a microcontroller having a plurality of specific time span of time values preset therein, a power unit regulating an output voltage of the power module and then providing a work voltage for the microcontroller, and a time control switch connected with the microcontroller for making choice of one time value so as to drive the microcontroller to send out corresponding control signals by means of counting down the time value selected by the time control switch. Then the driving circuit controls switch states of the electromagnetic relay according to the control signals, so as to further control whether there is power output to an external electric appliance or not.

### BACKGROUND OF THE INVENTION

1. Field of the Invention

The present invention generally relates to a power device, and more particularly to a timing power switch.

2. The Related Art

Power devices, such as plugs, are generally employed to be connected with a power supply so as to make the power supply provide power for electric appliances. However, the electric appliances, such as computers, have many peripheral appliances used at the same time. If the power devices are always connected with the power supply with power switches of the electric appliances not yet turned off, then a circuit will always be formed to continually consume a current so that results in waste of power. In addition, the electric appliances having their power devices always connected with the power supply may shorten their life due to long-term use. So the users often need to pull out all the power devices or turn off all the power switches of the electric appliances. It is inconvenient to use. So a power device having a timing switch function is required.

### SUMMARY OF THE INVENTION

An object of the present invention is to provide a timing power switch including a power module, a control module and a switch module. The power module is adapted for getting and dealing with an AC input voltage from an AC power supply to output a proper output voltage. The control module includes a microcontroller which has a plurality of specific time span of time values preset therein, a power unit for regulating and filtering the output voltage of the power module and then providing a work voltage for the microcontroller, and a time control switch which is connected with the microcontroller for making choice of one time value so as to drive the microcontroller to send out corresponding control signals by means of counting down the time value selected by the time control switch. The switch module has an electromagnetic relay and a driving circuit. The driving circuit controls switch states of the electromagnetic relay according to the control signals from the microcontroller, so as to further control whether the AC power supply outputs power to an external electric appliance or not. Wherein the switch states of the electromagnetic relay rest with whether the output voltage of the power module is provided thereon or not under the control of the driving circuit.

As described above, the timing power switch of the present invention drives the driving circuit to control the switch states of the electromagnetic relay and further control whether there is power on the external electric appliance or not, by means of utilizing the time control switch to make choice of one time value preset in the microcontroller so as to make the microcontroller output corresponding control signals to the driving circuit. Therefore, even if users forget to pull out all power devices of the electric appliances or turn off all power switches of the electric appliances, the timing power switch of the present invention still can avoid waste of power or damage of the electric appliances due to long-term use.

### BRIEF DESCRIPTION OF THE DRAWINGS

The present invention will be apparent to those skilled in the art by reading the following description, with reference to the attached drawings, in which:

FIG. 1 is a block diagram of a timing power switch according to an embodiment of the present invention;

FIG. 2 is a circuitry of a power module and a switch module of the timing power switch of FIG. 1;

FIG. 3 is a circuitry of a control module of the timing power switch of FIG. 1; and

FIG. 4 is a circuitry of a control module of a timing power switch according to another embodiment of the present invention.

### DETAILED DESCRIPTION OF THE EMBODIMENT

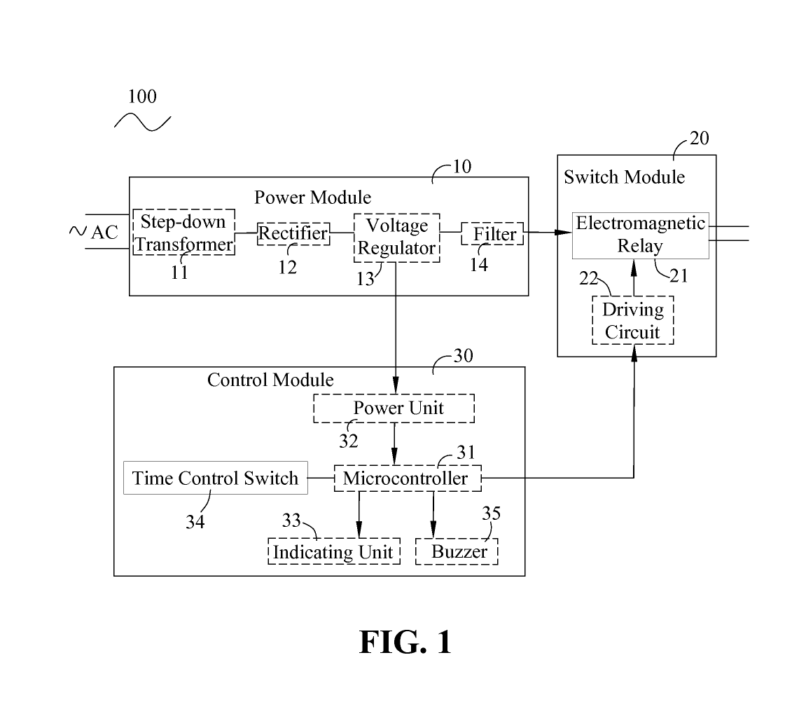

With reference to FIG. 1, a timing power switch 100 according to an embodiment of the prevent invention includes a power module 10, a switch module 20 and a control module 30.

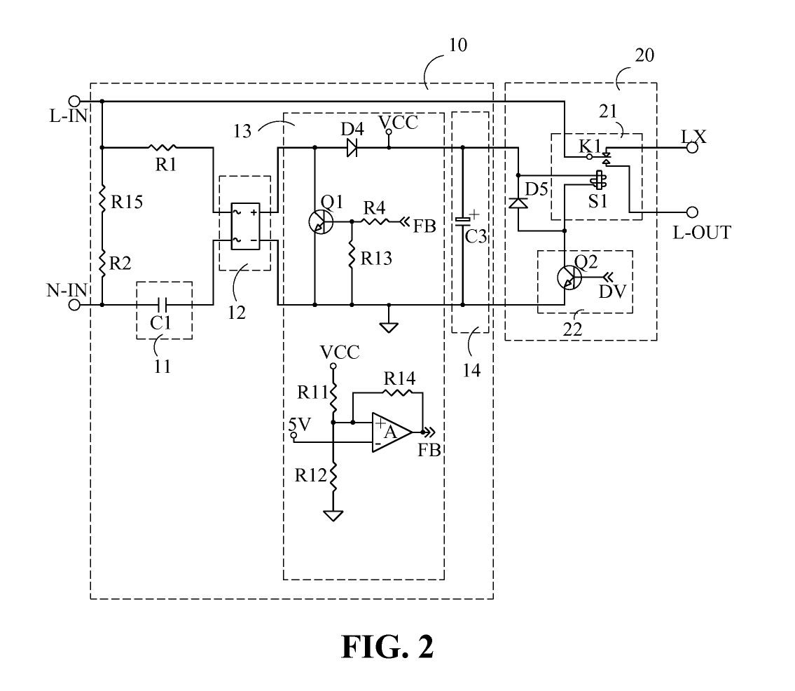

Referring to FIG. 1 and FIG. 2, the power module 10 is adapted to be connected with an AC power supply and includes a step-down transformer 11, a rectifier 12, a voltage regulator 13 and a filter 14 which are successively connected together. The voltage regulator 13 has a comparator A and a first transistor Q1 of which the collector and the emitter are respectively connected to positive and negative output ports of the rectifier 12. The negative output port of the rectifier 12 is further connected to ground. The non-inverting input of the comparator A is connected between a first voltage-dividing resistor R11 and a second voltage-dividing resistor R12 connected in series. Another two terminals of the first and the second voltage-dividing resistors (R11, R12) are respectively connected to a positive output terminal VCC of the power module 10 and ground. The inverting input of the comparator A is connected with a standard voltage which will be defined later. The output of the comparator A is connected with the base of the first transistor Q1 so as to control the switch states of the first transistor Q1 according to a voltage compared result of the non-inverting input with the inverting input. When the non-inverting input is at a higher voltage than the inverting input, namely a potential between the first voltage-dividing resistor R11 and the second voltage-dividing resistor R12 after an output voltage of the positive output terminal VCC is divided by the first and the second voltage-dividing resistors R11, R12 is higher than the standard voltage, the output of the comparator A outputs a positive voltage signal to control the first transistor Q1 connected. At this time, the positive output port of the rectifier 12 is short connected to ground, and the power module 10 has no voltage output. When the non-inverting input is at a lower voltage than the inverting input, the output of the comparator A outputs a negative voltage signal to control the first transistor Q1 disconnected. At this time, the power module 10 has a normal voltage output.

Referring to FIG. 1 and FIG. 2 again, the switch module 20 includes an electromagnetic relay 21 and a driving circuit 22. The driving circuit 22 has a second transistor Q2 of which the collector is connected to the positive output terminal VCC of the power module 10 through a directive diode D5, the emitter is connected to ground and the base is connected with the control module 30. The electromagnetic relay 21 is composed of a control system S1 parallel-connected to the directive diode D5, and a switch system K1 of which the stationary contact is connected with the AC power supply, and one movable contact is drawn forth as an output for connecting with an external electric appliance, wherein switch states of the switch system K1 are controlled according to whether the output voltage of the power module 10 is output on the control system S1 or not.

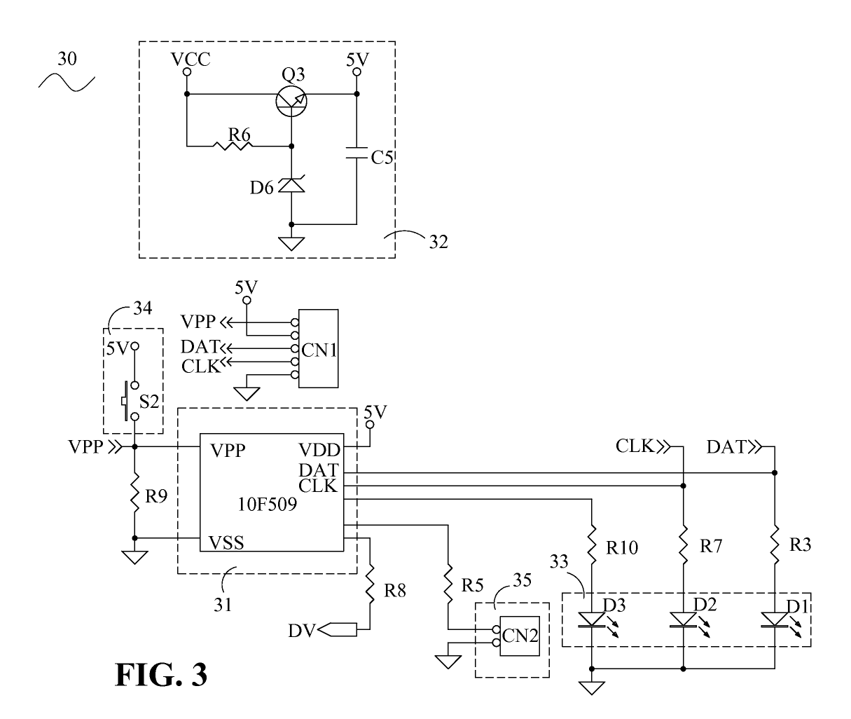

Referring to FIG. 1 and FIG. 3, the control module 30 includes a microcontroller 31, a power unit 32, an indicating unit 33, a time control switch 34 and a buzzer 35. The power unit 32 is connected between the power module 10 and the microcontroller 31, and can regulate and filter the output voltage of the power module 10 so as to provide a work voltage for the microcontroller 31. The power unit 32 includes a third transistor Q3 of which the collector is connected to the positive output terminal VCC of the power module 10, the base is on one hand connected to ground through a zener diode D6, and on the other connected to the collector through a resistor R6, and the emitter passes through a capacitor C5 to be connected to ground. The emitter of the third transistor Q3 is further connected with the microcontroller 31 to provide the work voltage for the microcontroller 31, wherein the work voltage is no other than the above mentioned standard voltage.

The indicating unit 33 includes a plurality of light-emitting diodes of which each is connected with an indicating port of the microcontroller 31, wherein the microcontroller 31 has a plurality of specific time span of time values preset therein, and each indicating port of the microcontroller 31 corresponds to one of the time values. The time control switch 34 is connected with the microcontroller 31 for making choice of one time value so as to control the microcontroller 31. Then the microcontroller 31 controls work states of the indicating unit 33 and counts down the time value selected by the time control switch 34. The control port of the microcontroller 31 is connected with the base of the second transistor Q2 of the driving circuit 22, for further controlling switch states of the second transistor Q2. The buzzer 35 is connected with the microcontroller 31.

Referring to FIGS. 1-3, when the timing power switch 100 is connected with the AC power supply, the light-emitting diodes light by turns under the control of the microcontroller 31. When the time control switch 34 makes choice of one of the time values preset in the microcontroller 31, the microcontroller 31 on one hand drives the light-emitting diode corresponding to the selected time value by the time control switch 34 to keep lighting and other light-emitting diodes to be gone out, and on the other hand controls the second transistor Q2 of the driving circuit 22 in a connected state. After the second transistor Q2 is connected, the output voltage of the power module 10 is provided on the control system 51 of the electromagnetic relay 21. Therefore, the switch system K1 is closed, and the AC power supply outputs power to the external electric appliance. Simultaneously, the microcontroller 31 begins to count down the selected time value by the time control switch 34. When the countdown of the selected time value is finished, the microcontroller 31 drives the buzzer 35 to sound an alarm. The second transistor Q2 of the driving circuit 22 is disconnected under the control of the microcontroller 31. As a result, the switch system K1 is opened due to the status of no voltage on the control system S1. So there is no power provided for the external electric appliance.

As described above, the timing power switch 100 of the present invention drives the driving circuit 22 to control the switch states of the electromagnetic relay 21 and further control whether there is power on the external electric appliance or not, by means of utilizing the time control switch 34 to make choice of one time value preset in the microcontroller 31 so as to make the microcontroller 31 output corresponding control signals to the driving circuit 22. Therefore, even if users forget to pull out all power devices of the electric appliances or turn off all power switches of the electric appliances, the timing power switch 100 of the present invention still can avoid waste of power or damage of the electric appliances due to long-term use.

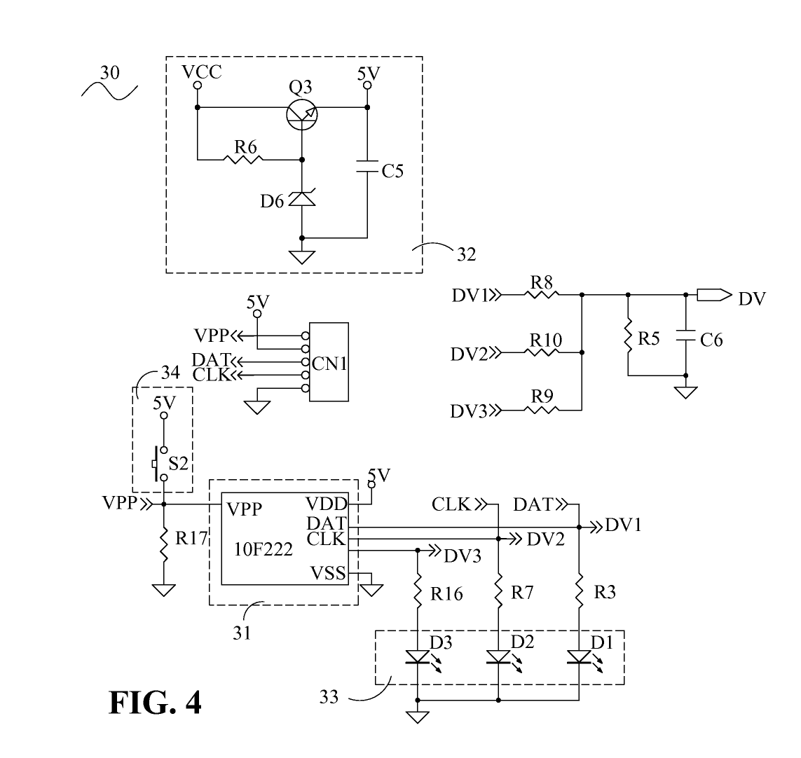

The foregoing description of the present invention has been presented for purposes of illustration and description. It is not intended to be exhaustive or to limit the invention to the precise form disclosed, and obviously many modifications and variations are possible in light of the above teaching. For example, the buzzer 35 may be omitted as shown in FIG. 4. Such modifications and variations that may be apparent to those skilled in the art are intended to be included within the scope of this invention as defined by the accompanying claims.

What is claimed is:

1. A timing power switch, comprising:
a power module for getting and dealing with an AC input voltage from an AC power supply to output a proper output voltage;
a control module including a microcontroller which has a plurality of specific time span of time values preset therein, a power unit for regulating and filtering the output voltage of the power module and then providing a work voltage for the microcontroller, and a time control switch which is connected with the microcontroller for making choice of one time value so as to drive the microcontroller to send out corresponding control signals by means of counting down the time value selected by the time control switch; and
a switch module having an electromagnetic relay and a driving circuit, the driving circuit controlling switch states of the electromagnetic relay according to the control signals from the microcontroller, so as to further control whether the AC power supply outputs power to an external electric appliance or not, wherein the switch states of the electromagnetic relay rest with whether the output voltage of the power module is provided thereon or not under the control of the driving circuit.

2. The timing power switch as claimed in claim 1, wherein the control module further includes an indicating unit which has a plurality of light-emitting diodes respectively connected with indicating ports of the microcontroller so as to be driven to light by turns, each indicating port of the microcontroller corresponds to one of the time values, when the time control switch makes choice of one of the time values, the microcontroller drives the light-emitting diode corresponding to the selected time value by the time control switch to keep lighting and other light-emitting diodes to be gone out, and at this time, the microcontroller begins to count down the selected time value.

3. The timing power switch as claimed in claim 1, wherein the control module further includes a buzzer connected with the microcontroller, when the countdown of the selected time value by the time control switch is finished, the microcontroller drives the buzzer to sound an alarm.

4. The timing power switch as claimed in claim 1, wherein the power unit includes a transistor of which the collector is connected with a positive output terminal of the power module, the base is on one hand connected to ground through a zener diode, and on the other connected to the collector through a resistor, and the emitter passes through a capacitor to be connected to ground, the emitter of the transistor is further connected with the microcontroller to provide the work voltage for the microcontroller.

5. The timing power switch as claimed in claim 1, wherein the driving circuit of the switch module has a transistor of which the collector is connected to a positive output terminal of the power module through a directive diode and the emitter is connected to ground, the electromagnetic relay comprises a control system parallel-connected to the directive diode and a switch system connected between the AC power supply and the external electric appliance, the microcontroller of the control module is connected with the base of the transistor so as to control switch states of the transistor and further control whether the output voltage of the power module is provided on the control system or not.

6. The timing power switch as claimed in claim 1, wherein the power module includes a step-down transformer, a rectifier, a voltage regulator and a filter which are successively connected together.
